(19) United States
(12) Patent Application Publication
(10) Pub. No.: US 2007/0107996 A1
(43) Pub. Date: May 17, 2007

(54) Pair of brake linings for a disk brake

(75) Inventors: Markus Gruber, Steinhoering (DE); Dietmar Knoop, Ebenhausen (DE); Thomas Lipp, Eichenau (DE); Wlodzimierz Macke, Olching (DE); Josef Schropp, Eichendorf (DE)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE SYSTEME FUER NUTZFAHRZEUGE GMBH, Muenchen (DE)

(21) Appl. No.: 11/514,942

(22) Filed: Sep. 5, 2006

Related U.S. Application Data
(63) Continuation of application No. PCT/EP05/02184, filed on Mar. 2, 2005.

(30) Foreign Application Priority Data
Mar. 2, 2004 (DE) 10 2004 010 314.3

(51) Int. Cl. F16D 65/00

(52) U.S. Cl. 188/73.1

(57) ABSTRACT

A pair of brake linings for a disk brake, particularly a disk brake with a sliding caliper, including one brake lining which is actively connected on the clamping side to a clamping device and one brake lining on the reaction side, each having a lining carrier plate and a friction lining which are frictionally arranged on a brake disk in a braking position. The pair of brake linings is embodied in such a way that the clamping-sided and reaction-sided lining carrier plate are adapted, configured and dimensioned differently corresponding to the respectively occurring loads and construction areas of the brake caliper.

This application is a Continuation of PCT/EP2005/002184, filed Mar. 2, 2005, and claims the priority of DE 10 2004 010 314.3, filed Mar. 3, 2004, the disclosures of which are expressly incorporated by reference herein.

### BACKGROUND AND SUMMARY OF THE INVENTION

The present invention relates to a pair of brake linings for a disk brake, and in particular brake lining adapted according to the loads which occur and according to the installation spaces of the brake caliper.

For example, German patent publication DE 42 30 005 A1 has disclosed a brake which is configured as a sliding caliper disk brake and can be installed in a vehicle, in particular a commercial vehicle.

In addition to a brake disk, this disk brake also comprises two brake linings which form a pair of brake linings and can be pressed against the friction faces of a brake disk during a braking operation.

Here, the brake disk is surrounded by a displaceably mounted brake caliper, on one side of which a brake application device, which is preferably actuated by compressed air, is arranged, with which the brake application-side brake lining is pressed against the brake disk. On account of the reaction forces which occur during application of the brake application-side brake lining against the brake disk, the brake caliper is displaced in the opposite direction with simultaneous driving and contact of the reaction-side brake linings on the brake disk.

Each of the two brake linings comprises a lining carrier plate and a friction lining which is connected thereto and bears frictionally against the associated friction face of the brake disk in the use position.

In order to absorb the considerable loads, in particular flexural stresses, which occur in the operating position, it is required to dimension the thickness of the lining carrier plates correspondingly. This relates equally to the design of the lining carrier plates with regard to shear stresses which occur in the connecting region between the respective friction lining and the associated lining carrier plate, very high requirements being placed on their connection, which result, moreover, from thermal loads, as exist during a braking operation as a result of the frictional heat produced.

The two brake linings of a pair of brake linings which have been used previously are dimensioned and configured without consideration of these loading differences.

As both the loadings of the brake linings and the conditions of the installation spaces on the brake application side and the reaction side are different, the known pairs of brake linings represent only a compromise, with regard to their dimensions and configuration. This means that the friction lining which is dependent in its thickness firstly on the overall thickness of the brake lining which is predefined to this extent and secondly on the load-dependent thickness of the lining carrier plate, cannot be designed in an optimum manner in every case.

In the case of a predefined brake lining thickness of, for example, 30 mm and a thickness of the lining carrier plate which is necessary to absorb the loading of 9 mm, a thickness of 21 mm remains for the friction lining, of which only 19 mm can be used as wear thickness, as the residual thickness of 2 mm forms a safety thickness as it were, the brake lining being exchanged when said safety thickness is reached. The abovementioned dimensions relate by way of example to the brake application-side brake lining, whereas the reaction-side brake lining can be oversized on account of the changed introduction of load.

In order to increase the wear thickness with retention of the overall thickness and therefore to increase the service life of the brake lining with the resultant cost advantages, it is known to provide the lining carrier plate, which is then manufactured from sheet metal, with an at least partially circumferential edge for reinforcement in the region of the outer circumference, which edge is bent over in the direction which faces away from the friction lining, via which edge admittedly a certain flexural rigidity is achieved, but which is not sufficient on account of the lack of a corresponding feature in the face of the lining carrier plate, with the result that this construction does not satisfy the set requirements to a sufficient extent.

The double-sided use of the lining carrier plate, the configuration and dimensions of which have to satisfy the respective loadings and installation-space conditions, therefore represents a compromise as it were, which counteracts optimized design.

The present invention is therefore based on the object of developing a pair of brake linings in such a way that it is optimized for the respective purpose and location of use.

This object is achieved by a pair of brake linings in which the brake application-side lining carrier plate and the reaction-side lining carrier plate have different configurations and dimensions which are adapted according to the loads which occur and according to the installation spaces of the brake caliper.

As a result of this structural configuration, the two brake linings of the pair of brake linings can then be optimized in each case both with regard to their loadability and also with regard to their service life.

Independently of the conditions of the respectively other installation space and the loadings which act on the other brake lining, the lining carrier plate of the respective brake lining is configured in such a way that it is adapted precisely to the prevailing spatial and load conditions.

Inter alia, this has the consequence that the wear volume of the friction lining, above all its thickness, can be selected to be greater, without exceeding the overall thickness of the brake lining.

Therefore, for example, reinforcing ribs can be provided on the respective lining carrier plate, which reinforcing ribs can be placed where permitted by the installation space without problems.

Depressions and/or elevations and holes in the or on the lining carrier plate can also be provided, which are preferably provided with undercuts and correspond in a form-fitting manner to the friction lining, there being sufficient shear strength and also sufficient strength in other loading directions as a result.

The lining carrier plates can be configured as shaped sheet metal parts. However, they are preferably manufactured as a cast part, which results in the possibility of flexible shaping, as a result of which, in particular, the abovementioned reinforcing ribs and form-fitting parts can be manufactured.

The elevations, depressions or holes which are designed in terms of their shape in accordance with the requirements can be arranged in such a way that no reduction in flexural rigidity is associated. To this extent, the invention affords considerable freedom for a load-dependent design of the lining carrier plates.

The invention also provides a disk brake having a pair of brake linings according to the invention.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a disk brake according to the invention in a diagrammatic plan view,

FIGS. 2 and 3 show the two lining carrier plates of the pair of brake linings in each case in a rear view,

FIG. 4 shows a front view of the lining carrier plate according to FIG. 2,

FIG. 5 shows a cross section through a partial detail of the lining carrier plate according to FIG. 3, and

FIG. 6 shows a cross section through a partial detail of the lining carrier plate according to FIG. 2.

### DETAILED DESCRIPTION

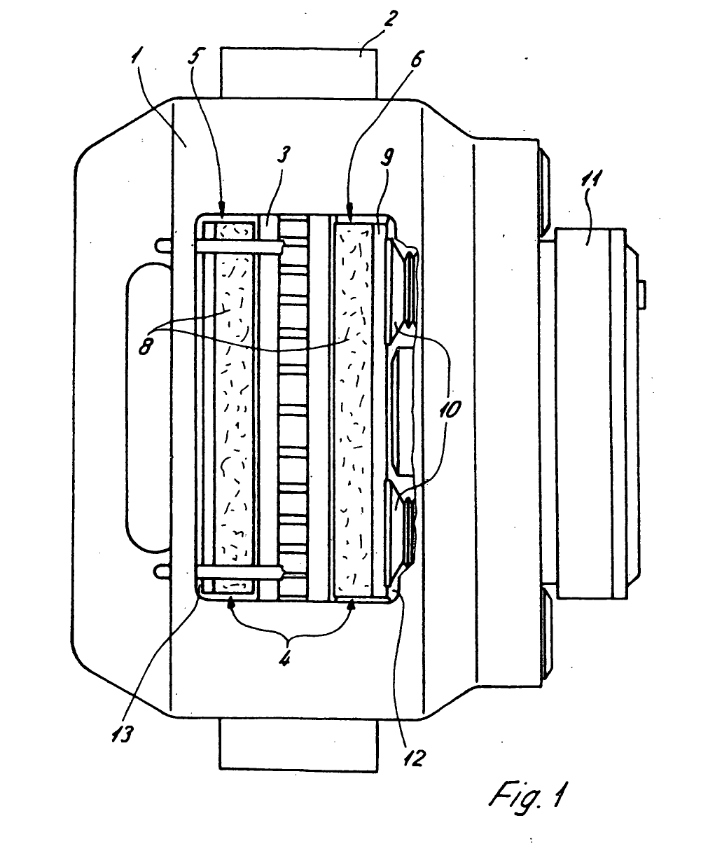

FIG. 1 shows a sliding caliper disk brake which is preferably actuated by compressed air and is fastened by means of a brake carrier 2 to a commercial vehicle (not shown).

The sliding caliper disk brake has a sliding caliper 1 which encloses a brake disk 3 which is fastened to an axle (not shown) of the commercial vehicle. The brake caliper 1 is arranged on the brake carrier 2 in an axially displaceable manner, in relation to the brake disk 3.

In each case one brake lining 5, 6 is provided on both sides of the brake disk 3, which together form a pair 4 of brake linings and of which the right-hand, brake application-side brake lining can be pressed against the brake disk 3 during a braking operation by means of a brake application device 11 via pressure pieces 10. Here, the brake application-side brake lining 6 is positioned in an installation space 12 of the brake caliper 1, and the reaction-side brake lining 5 is positioned in the installation space 13, which installation spaces 12, 13 differ in terms of their shape and their dimensions on account of the installed components.

There are also differences with regard to the loading of the respective brake linings 5, 6, of which each comprises a lining carrier plate 7, 9 and a brake lining 8.

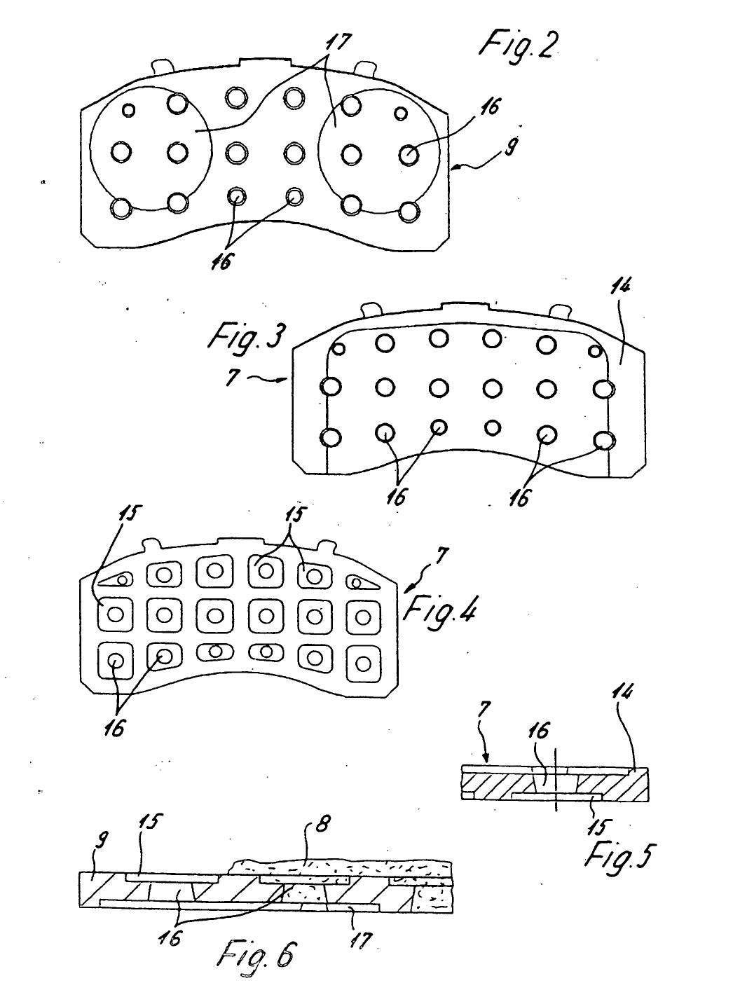

According to the invention, the brake application-side lining carrier plate 9 and the reaction-side lining carrier plate 7 have different configurations and dimensions which are adapted in accordance with the respectively occurring loads and the installation spaces 12, 13 of the brake caliper 1. This can be seen particularly clearly in FIGS. 2 to 6.

Here, FIG. 2 shows the rear side of the brake application-side lining carrier plate 9, that is to say the side which faces away from the friction lining 8, in which cutouts 17 are provided for accommodating the pressure pieces 10.

Furthermore, holes 16 are arranged over the entire surface area, which holes 16, as can be seen in the cross-sectional illustration in FIG. 6, open into depressions 15 on their side which faces the friction lining 8, which can also be seen in FIG. 4, and widen conically in the opposite direction. The material webs which are thus formed between the depressions 15 act in the manner of reinforcing ribs, as a result of which the overall thickness of the respective lining carrier plate 7, 9 can be reduced.

In this context, the lining carrier plate 7 of FIG. 3 can also be seen, the outer edge region of which is kept partially thicker, as a result of which a reinforcing edge 14 is formed. The latter has an advantageous effect on the surface pressure which is produced during a braking operation and results from the occurring support. As there is a relatively great overlap region for this support by the reinforcing edge 14, the minimum permissible disk thickness can likewise be optimized.

The conical widening of the holes 16 is to be seen, for example, as an undercut. However, it is also conceivable to make undercuts in a different shape, with the result that the material of the friction lining 8 which lies therein is embedded in a form-fitting manner.

As has already been described in the introduction of the description, the overall thickness of the lining carrier plate according to the prior art is, for example, 9 mm. In contrast, the novel lining carrier plates can be reduced to a thickness, which is relevant for installation, of 7 mm in the case of a corresponding arrangement and dimensioning of the ribs, with identical loadability. This results in an increase in the thickness of the friction lining 8 of 2 mm and a corresponding increase in the service life of the brake linings overall.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of Designations

1 Brake caliper
2 Brake carrier
3 Brake disk
4 Pair of brake linings
5 Brake lining
6 Brake lining
7 Lining carrier plate
8 Friction lining
9 Lining carrier plate
10 Pressure piece
11 Brake application device
12 Installation space
13 Installation space
14 Reinforcing edge
15 Depression
16 Hole
17 Cutout

What is claimed is:

1. A pair of brake linings for a disk brake having a brake caliper, comprising:
a brake application-side brake lining which is operatively connected to a brake application device of the brake caliper;
a reaction-side brake lining wherein
both linings each have a lining carrier plate and a friction lining fastened to its respective carrier plate, each of the friction linings bearing frictionally against a brake disk when in a braking position,
the brake application-side lining carrier plate and the reaction-side lining carrier plate having different configurations and dimensions which are adapted according to the loads and installation spaces of the brake caliper.

2. The pair of brake linings as claimed in claim 1, wherein each lining carrier plate is provided with reinforcing ribs.

3. The pair of brake linings as claimed in claim 1, wherein each lining carrier plate has at least one of depressions and holes.

4. The pair of brake linings as claimed in claim 3, wherein the at least one of depressions and holes are provided with undercuts.

5. The pair of brake linings as claimed in claim 4, wherein the holes are configured in a conically expanding manner in a direction facing away from the friction lining.

6. The pair of brake linings as claimed in claim 5, wherein the holes open into the depressions.

7. The pair of brake linings as claimed in claim 6, wherein the reaction-side lining carrier plate is provided with a partially circumferential reinforcing edge.

8. The pair of brake linings as claimed in claim 1, wherein the reaction-side lining carrier plate is provided with a partially circumferential reinforcing edge.

9. The pair of brake linings as claimed in claim 3, wherein the depressions are provided on that side of the lining carrier plate which faces the friction lining.

10. The pair of brake linings as claimed in claim 1, wherein the lining carrier plates are cast parts.

11. The pair of brake linings as claimed in claim 1, wherein the lining carrier plates are sheet metal parts.

12. A disk brake, comprising:
a brake caliper which straddles a brake disk when in an operative position;
a brake disk;
a pair of brake linings for a disk brake having a brake caliper, the brake linings including:
a brake application-side brake lining which is operatively connected to a brake application device of the brake caliper;
a reaction-side brake lining
wherein
both linings each have a lining carrier plate and a friction lining fastened to its respective carrier plate, each of the friction linings bearing frictionally against a brake disk when in a braking position,
the brake application-side lining carrier plate and the reaction-side lining carrier plate having different configurations and dimensions which are adapted according to the loads and installation spaces of the brake caliper.
